(19) United States
(12) Patent Application Publication
(10) Pub. No.: US 2015/0144601 A1
(43) Pub. Date: May 28, 2015

(54) RESPOT JIG

(71) Applicant: Hyundai Motor Company, Seoul (KR)

(72) Inventors: Jung Whan Yeum, Gunbuk-myeon (KR); Jin Hoon Park, Suwon-si (KR)

(73) Assignee: Hyundai Motor Company, Seoul (KR)

(21) Appl. No.: 14/265,233

(22) Filed: Apr. 29, 2014

(30) Foreign Application Priority Data
Nov. 22, 2013 (KR) 10-2013-0143137

(51) Int. Cl. B23K 37/04; B23K 11/00; B62D 65/00; B23K 11/11

(52) U.S. Cl. CPC B23K 37/0443; B23K 11/115; B23K 11/002; B62D 65/00
USPC 219/86.24

(57) ABSTRACT

A respot jig is capable of easily moving a welding gun to any welding position and controlling positions of various kinds of workpieces. The respot jig includes: a jig having a flat shape; welding systems installed at both sides of an upper portion of the jig and including a five-shaft rotating unit and a welding gun connected to an upper end of the five-shaft rotating unit, respectively; and an aligning and controlling system installed on the jig between the welding systems and including at least one swivel clamp unit and at least one aligning unit.

### CROSS-REFERENCE TO RELATED APPLICATION

The present application claims priority of Korean Patent Application Number 10-2013-0143137 filed Nov. 22, 2013, the entire contents of which application is incorporated herein for all purposes by this reference.

### BACKGROUND OF INVENTION

1. Field of Invention

The present invention relates to a respot jig, and more particularly, to a respot jig capable of easily moving a welding gun to any welding position and controlling positions of various kinds of workpieces.

2. Description of Related Art

According to the related art, as shown in FIG. 1, a welding gun 95 has been installed at a six-shaft multi-joint robot 90 to perform respot welding. However, the multi-joint robot 90 has a complicated structure and many shafts, such that it was difficult to implement a position control.

In addition, according to the related art, since interference was present between a control unit controlling a position of a workpiece and the welding gun and a respot welding process has been performed as two or more processes in order to satisfy a work cycle time, a control jig for each process, a gripper for transferring a component between the processes, the welding gun for respot welding, and a robot were required, such that a process was complicated and an equipment investment cost has been increased.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Accordingly, various aspects of the present invention have been made to solve the above-mentioned problems occurring in the prior art while advantages achieved by the prior art are maintained intact.

Various aspects of the present invention provide for a respot jig capable of easily moving a welding gun to any welding position and controlling positions of various kinds of workpieces.

Various aspects of the present invention provide for a respot jig including: a jig having a flat shape; welding systems installed at both sides of an upper portion of the jig and including a five-shaft rotating unit and a welding gun connected to an upper end of the five-shaft rotating unit, respectively; and an aligning and controlling system installed on the jig between the welding systems and including at least one swivel clamp unit and at least one aligning unit.

The five-shaft rotating unit may include first to fifth shafts sequentially disposed from a surface of the jig to a connection portion between the five-shaft rotating unit and the welding gun, the first and second shafts, which are linearly moving shafts, may be perpendicular to each other and be disposed in parallel with the surface of the jig, the third shaft may rotate around a rotation axis perpendicular to the first and second shafts, the fourth shaft may linearly move in a rotation axis direction of the third shaft, and the fifth shaft may rotate around a rotation axis on an upper end portion of the fourth shaft that is in parallel with the surface of the jig.

At least one of the first, second, and fourth shafts may include: a linear guide formed in a linear movement direction; a carriage linearly moving along the linear guide and having the next shaft of a corresponding shaft disposed on an upper surface thereof; and a moving unit moving the carriage.

The moving unit may include: a motor; a belt connected to an output shaft of the motor; and a ball screw connected to the belt and fitted into the carriage.

At least one of the third and fifth shafts may include: a motor generating rotational force; a ball screw formed at an output shaft of the motor; a rack fitted into the ball screw to move in a length direction of the ball screw depending on rotation of the ball screw; a pinion engaged with the rack to thereby rotate; and a mounting part rotating together with the pinion and having the next shaft of a corresponding shaft or the welding gun disposed thereon.

The swivel clam unit may include: an electric cylinder ascending and descending vertically to a surface of the jig; and a swivel clamp installed at an upper end of the swivel clam unit and performing clamping depending on an angle of a clamped surface of a workpiece to be clamped.

The aligning unit may include: an electric cylinder ascending and descending vertically to a surface of the jig; a locator installed at an upper end of the aligning unit having a workpiece seated thereon; and a guide bar extended upwardly from the locator and guiding the workpiece to the locator when the workpiece is seated.

The electric cylinder ascending and descending vertically to the surface of the jig may be installed over another electric cylinder installed on the surface of the jig so as to move in parallel with the surface of the jig.

The respot jig may further include an integrated controller including a communication module connected to the five-shaft rotating unit, the welding gun, the swivel clamp unit, and the aligning unit to process input and output signals and a power supply supplying power required for driving and operation, wherein the integrated controller is attached to the jig and the integrated controller has a teaching pendant connected thereto.

The teaching pendant may set the aligning and controlling system of the respot jig for each kind of vehicle, set a position value of the welding system, and set pressing force and welding current of the welding gun.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of a six-shaft multi-joint robot according to the related art and a welding gun installed at a front end portion of the six-shaft multi-joint robot;

FIG. 2 is a perspective view showing a state in which a workpiece is put on an exemplary respot jig according to the present invention;

FIG. 3 is a perspective view showing an exemplary welding system according to the present invention;

FIG. 4 is a perspective view showing a five-shaft rotating unit of the welding system of FIG. 3;

FIG. 5 is a perspective view showing a structure of a linear moving shaft of the five-shaft rotating unit of FIG. 4;

FIG. 6 is a perspective view showing a structure of a rotation moving shaft of the five-shaft rotating unit of FIG. 4;

FIG. 7 is a perspective view of a welding gun;

FIG. 8 is a view showing a workpiece and controlled positions for aligning and controlling positions of the workpiece;

FIG. 9 is a view showing a state in which the workpiece is aligned and controlled by an aligning and controlling system of the exemplary respot jig according to the present invention;

FIG. 10 is a perspective view showing a swivel clamp unit of the aligning and controlling system of FIG. 9;

FIG. 11 is a perspective view showing an arranging unit of the aligning and controlling system of FIG. 9; and

FIG. 12 is a view showing a connection state between an integrated controller of the exemplary respot jig according to the present invention and a teaching pendant.

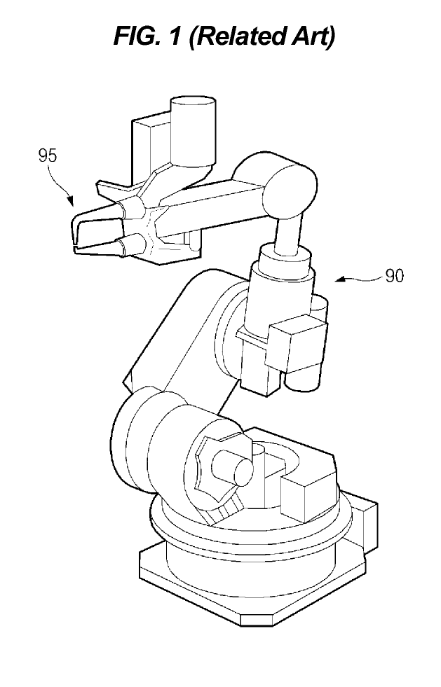

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

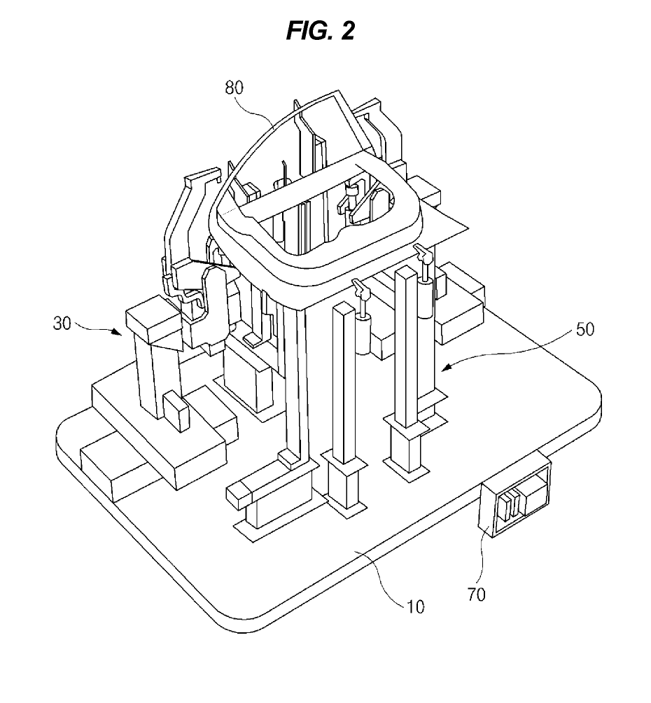

FIG. 2 is a perspective view showing a state in which a workpiece is put on a respot jig according to various embodiments of the present invention.

The respot jig according to various embodiments of the present invention includes welding systems 30 and an aligning and controlling system 50 installed on a jig 10 having a flat shape. The welding systems 30 are installed at both sides of an upper portion of the jig and performs welding a workpiece 80, and the aligning and controlling system 50 is disposed between the welding systems 30, fixes a workpiece, and controls a position of the workpiece.

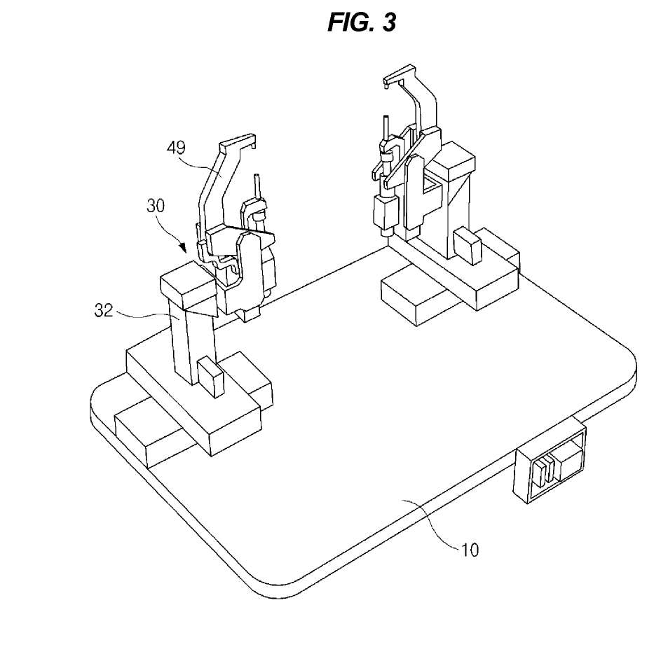

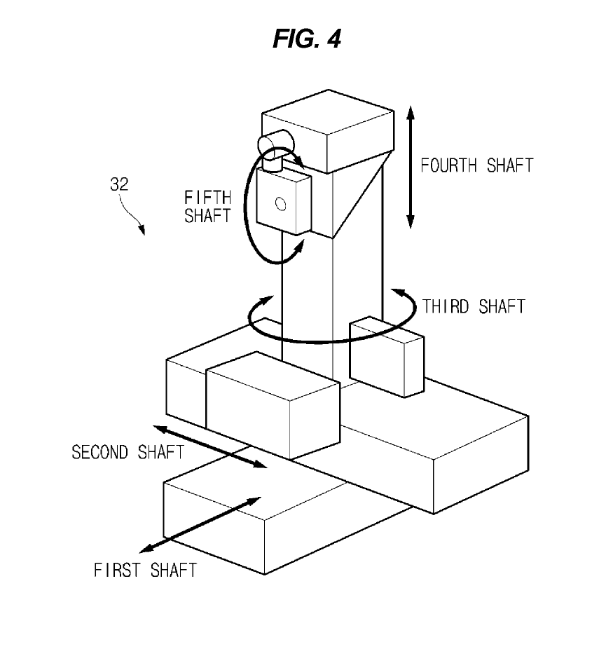

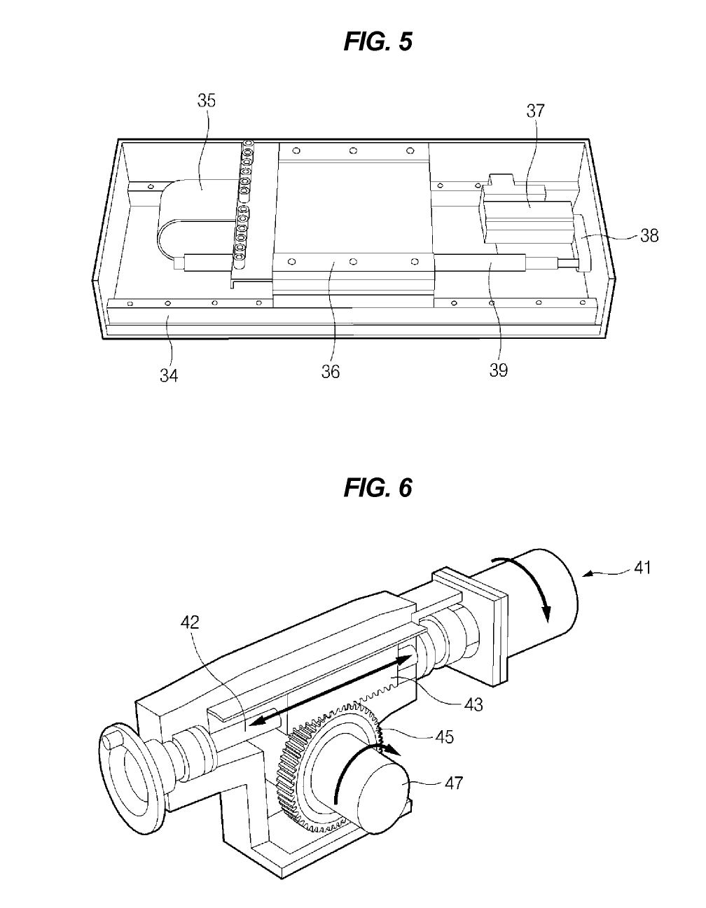

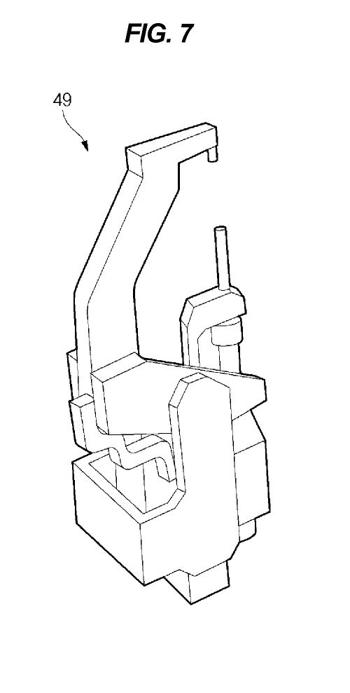

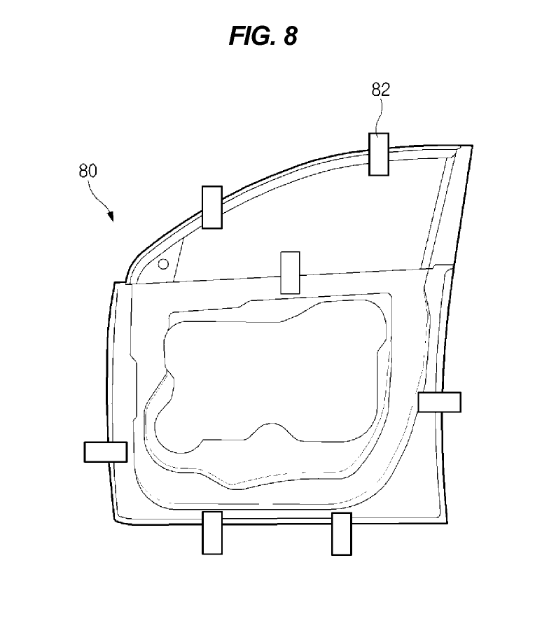

FIG. 3 is a perspective view showing a welding system according to various embodiments of the present invention; FIG. 4 is a perspective view showing a five-shaft rotating unit of the welding system of FIG. 3; FIG. 5 is a perspective view showing a structure of a linear moving shaft of the five-shaft rotating unit of FIG. 4; FIG. 6 is a perspective view showing a structure of a rotation moving shaft of the five-shaft rotating unit of FIG. 4; and FIG. 7 is a perspective view of a welding gun.

Referring to FIG. 3, the welding systems 30 according to various embodiments of the present invention are installed at both sides of the jig so as to face each other and include a five-shaft rotating unit 52 and a welding gun 49 connected to an upper end of the five-shaft rotating unit 52, respectively.

Referring to FIG. 4, the five-shaft rotating unit 32 includes first to fifth shafts sequentially disposed from a surface of the jig 10 to a connection portion between the five-shaft rotating unit 32 and the welding gun 49. First, the first and second shafts, which are linearly moving shafts, are perpendicular to each other and are disposed in parallel with the surface of the jig. Next, the third shaft, which is a rotating shaft, rotates around a rotation axis perpendicular to the first and second shafts.

The fourth shaft, which is a linearly moving shaft, is configured to linearly move in a rotation axis direction of the third shaft.

Finally, the fifth shaft, which is a rotating shaft, rotates around a rotation axis on an upper end portion of the fourth shaft that is in parallel with the surface of the jig. The welding gun 49 is connected to the fifth shaft.

Referring to FIGS. 4 and 5, the linearly moving first, second, and fourth shafts include a pair of linear guides 34 formed in a linear movement direction in a housing and a carriage 36 guided by the pair of linear guides 34 and linearly moving, respectively.

The carriage has the next shaft of a corresponding shaft disposed on an upper surface thereof. For example, the carriage of the first shaft has the second shaft disposed on an upper surface thereon, the carriage of the second shaft has third shaft disposed on an upper surface thereof, and the carriage of the fourth shaft has the fifth shaft disposed on an upper surface thereof.

The carriages 36 may be connected to each other by a cableveyor 35 to transfer an electrical signal to the next shaft.

The carriage moves by a moving unit. In various embodiments of the present invention, a motor 37 installed in the housing, a ball screw 39 disposed in parallel with the linear guide, and a belt 38 connecting an output shaft of the motor and the ball screw to each other to transfer rotational force may be implemented, and the carriage 36 is fitted into the ball screw 39, such that it linearly moves depending on rotation of the ball screw 39.

Next, referring to FIGS. 4 and 6, the third and fifth shafts, which perform rotation movement, includes a motor 41 generating rotational force, a ball screw 42 formed at an output shaft of the motor, a rack 43 fitted into the ball screw 42 to move in a length direction of the ball screw depending on rotation of the ball screw, a pinion 45 engaged with the rack to thereby rotate, and a mounting part 47 rotating together with the pinion 45 and having the next shaft of the corresponding shaft or the welding gun 49 disposed thereon, respectively.

Therefore, when the motor 41 rotates, the rotational force of the motor 41 is transferred to the ball screw 42, and the rack 43 fitted into the ball screw 42 linearly moves. In addition, the linearly moving rack 43 rotates the pinion 45 operating together with the mounting part 47. As a result, the mounting part 47 rotates by the rotation of the motor.

The mounting part has the next shaft of the corresponding shaft disposed thereon. For example, the mounting part of the third shaft has the fourth shaft disposed thereon, and the mounting part of the fifth shaft has the welding gun 49 disposed thereon.

This structure may obtain a large reduction gear ratio, such that it is advantage for precisely controlling a rotation angle and may also control a range of a rotatable angle by lengths of the rack and the ball screw.

In FIG. 7, a welding gun disposed on the mounting part of the fifth shaft is shown. The welding gun 49 may include a gun arm and a servo motor and control movement and pressing pressure of the gun arm by the servo motor. The welding gun is optimized so as to avoid interference with an aligning and controlling system and be smoothly movable.

In various embodiments of the present invention, since the welding gun may move depending to a welding position and it is possible to cope with any inclined surface of a workpiece by only three linear shafts perpendicular to each other and two rotation shafts perpendicular to each other, a structure much simpler and cheaper as compared with a six-shaft multi-joint robot according to the related art may be configured.

In addition, since three linear shafts perpendicular to each other are present, a coordinate system of the five-shaft rotating unit 32 and a coordinate system of the welding gun 49 may be easily implemented, such that teaching convenience is improved.

FIG. 8 is a view showing a workpiece and controlled positions for aligning and controlling positions of the workpiece.

As shown in FIG. 8, in various embodiments of the present invention, the aligning and controlling system 50 is implemented to have seven controlled positions 82. However, since the present invention is to be generally applied to various kinds of vehicles, it is obvious that these controlled positions may be changed and specific disposition of the aligning and controlling system 50 may be changed.

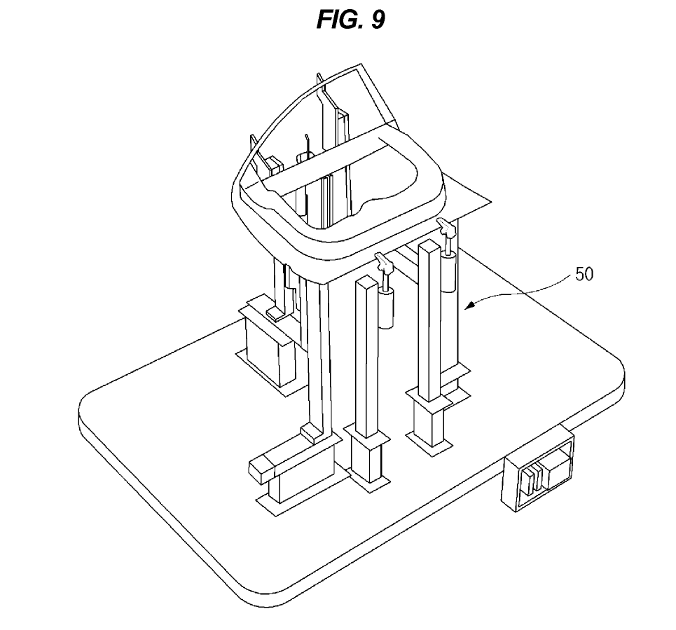

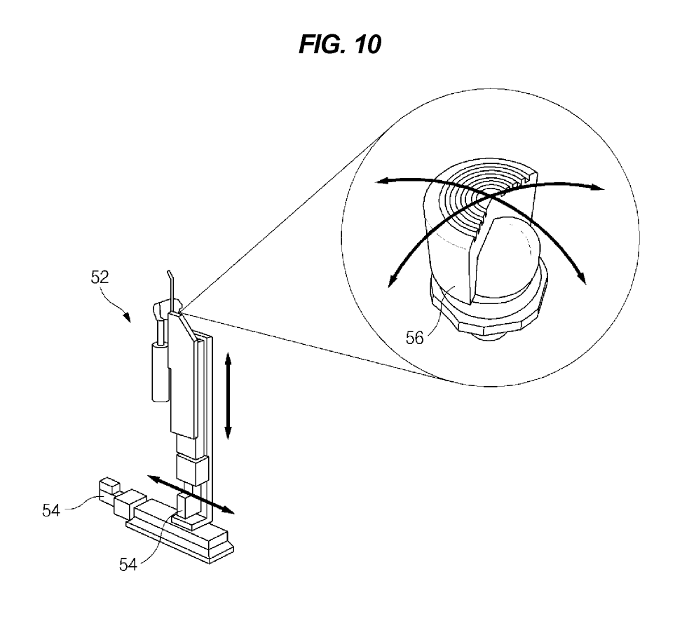

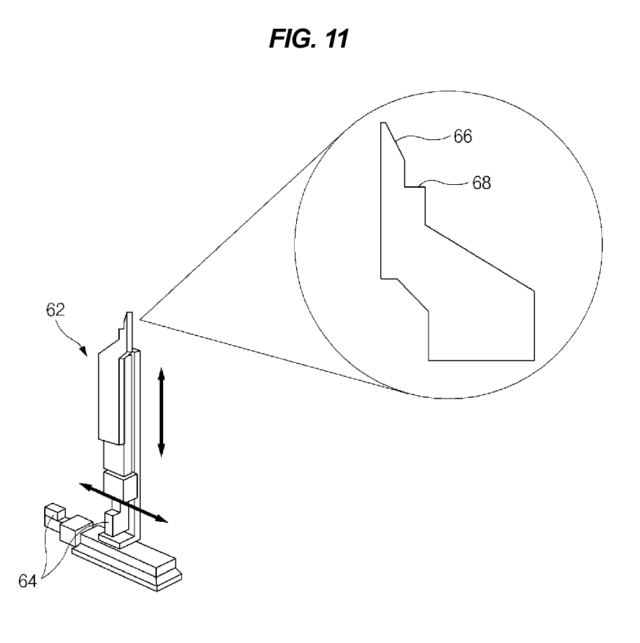

FIG. 9 is a view showing a state in which the workpiece is aligned and controlled by an aligning and controlling system of the respot jig according to various embodiments of the present invention; FIG. 10 is a perspective view showing a swivel clamp unit of the aligning and controlling system of FIG. 9; and FIG. 11 is a perspective view showing an arranging unit of the aligning and controlling system of FIG. 9.

Referring to FIG. 9, the aligning and controlling system 50 is installed on the jig between the welding systems described above.

The aligning and controlling system 50 includes at least one swivel clamp unit 52 and at least one aligning unit 62.

Referring to FIG. 10, the swivel clam unit 52 includes an electric cylinder 54 installed on the surface of the jig so as to move in parallel with the surface of the jig 10 and an electric cylinder 54 installed over the above-mentioned electric cylinder 54 and ascending and descending vertically to the surface of the jig.

Some of the electric cylinders 54 moving in parallel with the surface of the jig may be omitted depending on a kind of vehicle to which the aligning and controlling system is applied. That is, the electric cylinder 54 moving in a horizontal direction at a swivel clam unit 52 disposed at a specific position among a plurality of swivel clam units 52 may be omitted if necessary.

An upper end of the swivel clam unit 52 is provided with a swivel clamp 56 performing clamping depending on an angle of a clamped surface of a workpiece to be clamped, thereby making it possible to clamp the workpiece so as to be appropriate for the angle of the clamped surface.

Referring to FIG. 11, the aligning unit 62 includes an electric cylinder 64 installed on the surface of the jig so as to move in parallel with the surface of the jig 10 and an electric cylinder 64 installed over the above-mentioned electric cylinder 64 and ascending and descending vertically to the surface of the jig.

Some of the electric cylinders 64 moving in parallel with the surface of the jig may be omitted depending on a kind of vehicle to which the aligning and controlling system is applied. That is, the electric cylinder 64 moving in a horizontal direction at an aligning unit 62 disposed at a specific position among a plurality of aligning units 62 may be omitted if necessary.

An upper end of the aligning unit 62 is provided with a locator 68 on which the workpiece is seated and a guide bar 66 extended upwardly from the locator 68 and guiding the workpiece to the locator when the workpiece is seated.

Therefore, when the workpiece 80 is put on the aligning unit 62, it may be first located on the locator 68 by the guide bars 66 located at a plurality of places. In this case, the workpiece 80 may be fixed by the swivel clamp 56.

As a result, it may be appreciated that when these components are appropriately disposed, the aligning and controlling system 50 capable of coping with all kinds of vehicles may be designed.

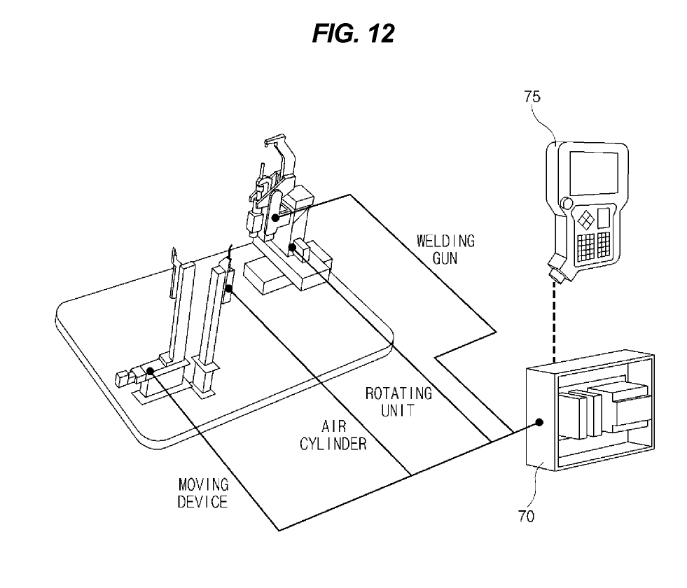

FIG. 12 is a view showing a connection state between an integrated controller of the respot jig according to various embodiments of the present invention and a teaching pendant.

The respot jig according to various embodiments of the present invention includes an integrated controller 70 including a communication module connected to the five-shaft rotating unit 32, the welding gun 49, the swivel clamp unit 52, and the aligning unit 62 to process input and output signals and a power supply supplying power required for driving and operation, wherein the integrated controller is attached to the jig 10, as shown in FIG. 2, or the like.

In addition, the teaching pendant 75 is connected to the integrated controller.

The teaching pendant sets the aligning and controlling system 50 of the respot jig for each kind of vehicle, sets a position value of the welding system 30, and sets pressing force and welding current of the welding gun 49.

In addition, the integrated controller may further include a backup module, in addition to the above-mentioned communication module and power supply.

The communication module processes input and output signals of the five-shaft rotating unit, the welding gun, the swivel clamp unit, and the electric cylinder and is connected to an external PLC.

The backup module duplicatively stores a position value of the motor so as to be the same as a position value stored in a motor drive at the time of performing teaching and copies position values for each kind of vehicle at the time of replacing the motor drive to allow the position values to be restored.

The power supply supplies power for driving the electric cylinder and the five-shaft rotating unit.

According to various embodiments of the present invention, the numbers of processes and equipments are decreased, thereby making it possible to decrease an investment cost, and a respot welding process may be completed in a single stage, thereby making it possible to simplify a process.

In addition, when the five-shaft rotating unit is individually used, it may also be used for welding another equipment, for example, a lower sill side of a main wall or a floor, thereby making it possible to decrease an investment cost and simplify an equipment. In addition, at the time of welding the floor, a large welding gun may be omitted and upper and lower portions may be separately welded, thereby making it possible to increase a speed of the welding.

For convenience in explanation and accurate definition in the appended claims, the terms upper or lower, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A respot jig comprising:
a jig having a flat shape;
welding systems installed at opposing sides of an upper portion of the jig, each including a five-shaft rotating unit and a welding gun connected to an upper end of the five-shaft rotating unit; and
an aligning and controlling system installed on the jig between the welding systems and including at least one swivel clamp unit and at least one aligning unit.

2. The respot jig according to claim 1, wherein the five-shaft rotating unit includes first, second, third, fourth and fifth shafts sequentially disposed from a surface of the jig to a connection portion between the five-shaft rotating unit and the welding gun;
the first and second shafts, which are linearly moving shafts, are perpendicular to each other and are disposed parallel to the surface of the jig;
the third shaft rotates around a rotation axis perpendicular to the first and second shafts;
the fourth shaft linearly moves in a rotation axis direction of the third shaft; and
the fifth shaft rotates around a rotation axis on an upper end portion of the fourth shaft that is parallel to the surface of the jig.

3. The respot jig according to claim 2, wherein at least one of the first, second, and fourth shafts includes:
a linear guide formed in a linear movement direction;
a carriage linearly moving along the linear guide and having the next shaft of a corresponding shaft disposed on an upper surface thereof; and
a moving unit moving the carriage.

4. The respot jig according to claim 3, wherein the moving unit includes:
a motor;
a belt connected to an output shaft of the motor; and
a ball screw connected to the belt and fitted into the carriage.

5. The respot jig according to claim 2, wherein at least one of the third and fifth shafts includes:
a motor generating rotational force;
a ball screw formed at an output shaft of the motor;
a rack fitted into the ball screw to move in a length direction of the ball screw depending on rotation of the ball screw;
a pinion engaged with the rack to thereby rotate; and
a mounting part rotating together with the pinion and having the next shaft of a corresponding shaft or the welding gun disposed thereon.

6. The respot jig according to claim 1, wherein the swivel clam unit includes:
an electric cylinder ascending and descending vertically to a surface of the jig; and
a swivel clamp installed at an upper end of the swivel clam unit and performing clamping depending on an angle of a clamped surface of a workpiece to be clamped.

7. The respot jig according to claim 1, wherein the aligning unit includes:
an electric cylinder ascending and descending vertically to a surface of the jig;
a locator installed at an upper end of the aligning unit having a workpiece seated thereon; and
a guide bar extended upwardly from the locator and guiding the workpiece to the locator when the workpiece is seated.

8. The respot jig according to claim 6, wherein the electric cylinder ascending and descending vertically to the surface of the jig is installed over another electric cylinder installed on the surface of the jig so as to move parallel to the surface of the jig.

9. The respot jig according to claim 1, further comprising an integrated controller including a communication module connected to the five-shaft rotating unit, the welding gun, the swivel clamp unit, and the aligning unit to process input and output signals and a power supply supplying power required for driving and operation, wherein the integrated controller is attached to the jig.

10. The respot jig according to claim 9, wherein the integrated controller has a teaching pendant connected thereto;
the teaching pendant sets the aligning and controlling system of the respot jig for each kind of vehicle, sets a position value of the welding system, and sets pressing force and welding current of the welding gun.
